(19) United States
(12) Patent Application Publication
(10) Pub. No.: US 2016/0071155 A1
(43) Pub. Date: Mar. 10, 2016

(54) SMART RETAIL SPACE

(71) Applicants: SVEN HAIGES, MUENCHEN (DE); NICK WOOD, MANNHEIM (DE)

(72) Inventors: SVEN HAIGES, MUENCHEN (DE); NICK WOOD, MANNHEIM (DE)

(21) Appl. No.: 14/480,636

(22) Filed: Sep. 9, 2014

(51) Int. Cl. G06Q 30/02

(52) U.S. Cl. CPC G06Q 30/0261; G06Q 30/0269; G06Q 30/0267

(57) ABSTRACT

A cloud server system determines a selection of an item from a number of items within a retail space based on a user preference profile. The selection is determined by matching the user preference profile to one or more items located at the retail space. The cloud server system publishes the selection to a computer via a publisher socket. The computer receives the selection published by the cloud system via a subscriber socket. The computer is subscribed to listen for a message with topic an identifier of the retail space. A microcontroller outputs the selection to at least one electronic component upon receiving string data representing the selection from the computer. The at least one electronic component acts on the retail space in accordance with the determined selection.

### BACKGROUND

A smart environment is a notion where interconnected devices intelligently and autonomously communicate to create a convenient and personalized user experience. A smart environment acquires and applies knowledge over time to adapt the environment to its inhabitants in order to improve their experience. Physical spaces and objects may be embedded with a variety of devices of various types such as tags, sensors, controllers, etc., having different sizes such as nano, micro, or macro. Those devices may also communicate with computing services provided, for example, wirelessly and continuously.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates a system including hardware components installed in a retail space that communicate with a cloud server system, according to one embodiment.

FIG. 2 illustrates a process to select one or more objects in a physical retail space, according to one embodiment.

FIG. 3 illustrates a process to select one or more wines from a wine shelf, according to one embodiment.

FIG. 4 illustrates a process to match a user preference profile to one or more items located at a retail space section, according to one embodiment.

FIG. 5 illustrates a process to capture real-time physical selections of objects from a physical retail space, according to one embodiment.

FIG. 6 illustrates a process to capture real-time selections of wines from a shelf, according to one embodiment.

FIG. 7 illustrates an exemplary computer system, according to one embodiment.

### DETAILED DESCRIPTION

Embodiments of techniques smart retail space are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

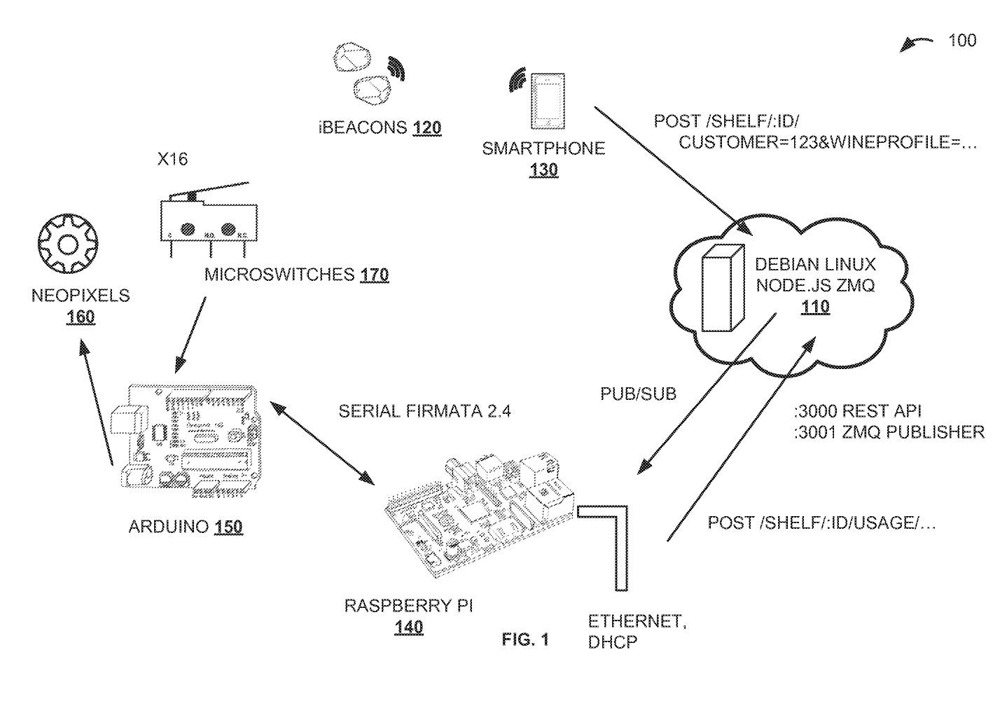

FIG. 1 illustrates system 100 including hardware components installed in a retail space that communicate with cloud server system 110. System 100, upon detecting a user's presence, triggers a selection of one or more objects based on a predefined preference profile of the user. In one embodiment, the one or more objects are selected from a retail section of the retail space such as a shelf. Further, user's action selecting the one or more objects may trigger sending data to the cloud server system 110 to be analyzed, according to one embodiment. Physical user interaction with the retail space is detected or sensed by the hardware components installed in the retail space such as one or more MicroSwitches 170. Detected interactions of the user with the retail space are sent to the cloud server system 110 to be analyzed.

System 100 may use wireless sensors or transmitters to detect a presence of a user. An example of a transmitter may be an iBeacon® provided by Apple Inc. that uses Bluetooth low energy proximity sensing and transmits a universally unique identifier that may be picked up by compatible applications or operating systems. A transmitter is physically attached to and logically associated with a corresponding retail space section in the retail space. For example, an iBeacon form iBeacons 120 may be attached to a wine shelf. In one embodiment, the transmitter broadcasts signals that may be detected by a mobile application running on a mobile device. In one embodiment, iBeacons 120 may be transmitting identifiers identifying retail space sections, where each of the retail space sections may be associated with a corresponding iBeacon from iBeacons 120.

The mobile application running on a mobile device may identify a retail space section in proximity to the mobile device by detecting the retail space section identifier transmitted by a transmitter attached to the retail space section. For example, a mobile application running on smartphone 130 may identify a wine shelf in proximity based on wine shelf identifier transmitted by a corresponding iBeacon from iBeacons 120. The corresponding iBeacon from iBeacons 120 is attached to the wine shelf.

Cloud server system 110 may expose a public application programming interface (API) for client systems such as applications running on smartphone 130 to interface and communicate with the cloud server system 110. Cloud server system 110 may expose same or another API for receiving input data. The input data may represent physical interaction with the objects in the retail space such as a selection of an object from a shelf by uplifting the object, for example. In one embodiment, the API of cloud server system 100 for receiving input data connects to a computer. For example, the API of cloud server system 100 for receiving input data connects to a single-board computer such as Raspberry Pi 140. Another example of computer to which cloud server system 100 may connect is BeagleBoard. Any type of computer system that is small enough to fit within the retail space may be used. In one embodiment, Raspberry Pi 140 and the cloud API may communicate via a ZMQ messaging protocol. Examples for other messaging protocols that may be used include, but are not limited to, WebSocket®, Message Queue Telemetry Transport (MQTT), Constrained Application Protocol (CoAP) according to various embodiments. In the example illustrated in FIG. 1, cloud server system 110 may be running a Debian® Linux® operating system, a node.js® event-driven framework designed to build scalable network applications, and a ZMQ messaging queue, according to one embodiment. Alternative operating systems, frameworks for building network application, and messaging protocols may be used.

In one embodiment, upon detecting signals transmitted by the transmitter attached to the retail space section, a user preference profile may be sent in real-time by the mobile application running on the mobile device. For example, upon detecting an iBeacon from one or more iBeacons 120, a customer profile may be sent by the mobile application running on smartphone 130 to cloud server system 110. For example, the mobile application scans in the background for an iBeacon attached to a shelf in proximity and triggers sending of a wine preference profile data to the API at cloud server system 110. This API is the entry point for communication from external systems such as the mobile application.

In one embodiment, the mobile application running on smartphone 130 may be associated with a unique user identifier. In one embodiment, the unique user identifier may be used to block requests to system 100 from other nearby users, when system 100 has been recently used, for example. A user preference profile may be any data indicating taste or preferences of a user towards one or more items such as wines, perfumes, art objects, etc. The user preference profile may indicate customer's preferences for wines, for example.

In one embodiment, in addition to the user preference profile, the unique user identifier and the retail space section identifier are sent by the mobile application to the cloud server system. For example, the mobile application running on smartphone 130 may send a POST Hypertext Transfer Protocol (HTTP) request to cloud server system 110 that includes the wine shelf identifier, the customer identifier, and a customer wine preference profile data. Cloud server system 110 matches the incoming user preference profile to items associated with or present at a retail space section. For example, cloud server system 110 may determine wines located on the shelf, in proximity to smartphone 130, matching the received user preference profile. To match the incoming user preference profile to items at the retail space section, a mapping of the items to positions in the retail space section may be maintained by cloud server system 110.

In one embodiment, based on the received user preference profile, cloud server system 110 determines in real-time one or more objects in the retail space section that match the received user preference profile. The determined matching one or more objects to be selected. Cloud server system 110 sends a selection of the determined one or more objects to a computer such as Raspberry Pi 140. The determined selection of one or more objects may be sent by cloud server system 110 to Raspberry Pi 140 in a message via the ZMQ publisher queue. The message may have the retail space section identifier for a topic.

Raspberry Pi 140 may be a broker for communication between hardware components installed in the retail space and cloud server system 110. Such hardware components in the illustrated example in FIG. 1 may be Arduino® 150, NeoPixels® 160, and MicroSwitches® 170). Arduino® 150 senses the environment by receiving inputs from sensors, electric switches such as MicroSwitches® 170, and affects the surroundings by controlling lights such as NeoPixelsx 160, motors, and other actuators. Raspberry Pi 140 may be connected to the Internet, e.g., via Ethernet. Raspberry Pi 140 could maintain a ZMQ subscriber socket to listen for messages from cloud server system 110 with specific topic such as the retail space section identifier. Cloud server system 110 could maintain a ZMQ publisher socket via which to publish or deliver the determined selection. Thus, based on the publisher and subscriber mechanism of ZMQ, Raspberry Pi 140 could listen for and forward the determined selection of one or more objects to corresponding hardware components (e.g., Arduino 150 and NeoPixls 160) associated with the currently evaluated retail space section. The publisher and subscriber mechanism could allow for loose connection between Raspberry Pi 140 and cloud server system 110, thus permitting architecture of system 100 to scale, according to various embodiments.

In one embodiment, upon receiving the message including the determined selection, Raspberry Pi 140 sends string data to a microcontroller such as Arduino 150. For example, one Arduino may be associated with each shelf. The string data represents the determined selection of one or more objects. For example, the string may indicate the positions on the shelf from where the one or more objects are to be selected. Raspberry Pi 140 may be connected to Arduino 150 via USB. In one embodiment, Arduino 150 and the Raspberry Pi 140 may communicate via Firmata® or other standard protocol. Upon receiving the string, Arduino 150 outputs, in real-time, the determined selection to the hardware components installed in the physical retail space by sending signals to one or more electronic components. The one or more electronic components are installed in the retail space section currently evaluated. For example, lights such as NeoPixls 160 may be installed at different positions at the shelf. The one or more electronic components may act on the retail space section in accordance with the determined selection. For example, the string may indicate which light channels to be turned on. By turning on one or more lights from NeoPixels 160, system 100 indicates to the user the selection of the one or more objects. Arduino 150 lights up one or more lights from NeoPixels 160 in accordance with positions indicated in the received string representing the selection, according to one embodiment. Thus, system 100 intelligently may guide customer what items to select in a retail space based on the user's preferences simplifying the selection process for the user.

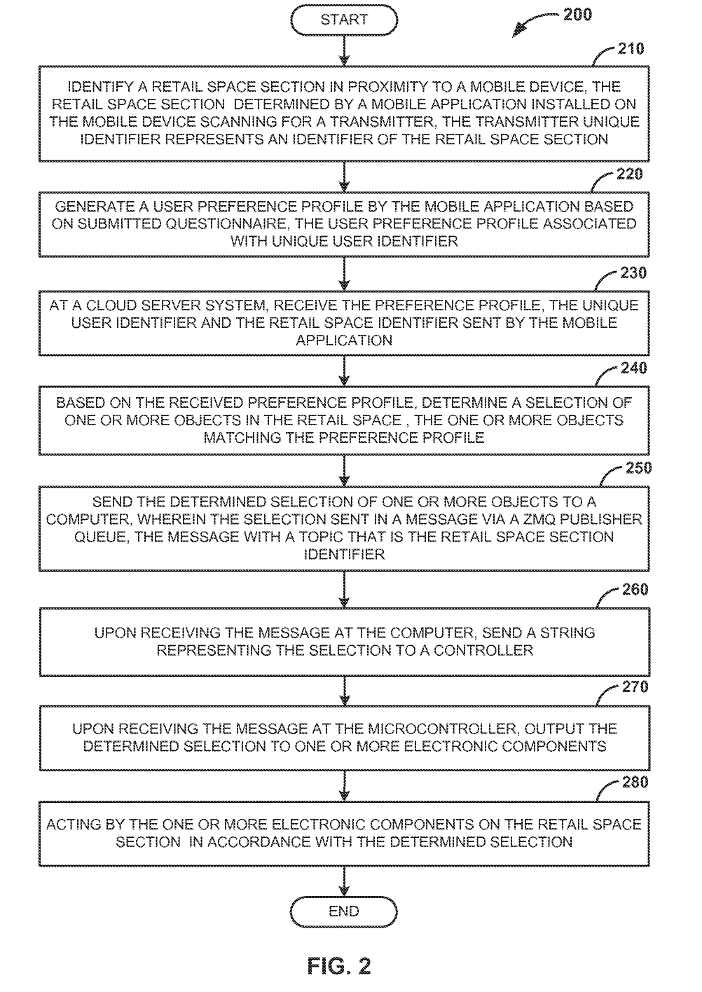

FIG. 2 illustrates process 200 to select one or more objects in a physical retail space, according to one embodiment. At 210, a retail space section in proximity to a mobile device is identified. The retail space section is identified by a mobile application installed on a mobile device by scanning for and receiving signals from a nearby transmitter. The mobile application pinpoints the location of the mobile device relative to the transmitter based on the signals from the transmitter. The transmitter may be attached to and associated with the retail space section. A unique identifier that the transmitter is transmitting is associated with and represents a unique identifier of the retail space section.

In one embodiment, upon detecting the transmitter in proximity, the mobile application may prompt a user of the mobile application to fill in and submit a questionnaire. The questionnaire may include questions related to a user's preference to various objects or items. At 220, a user preference profile may be generated by the mobile application. The user preference profile may be generated based on the submitted questionnaire. Alternatively or in combination, the user preference profile may be generated based on historic data, e.g., previous behavior of the user. In one embodiment, one or more user preference profiles may be defined. The one or more predefined profiles may be presented by the mobile application to the user for selection. For example, pre-defined profiles may be generated for different food or occasions suitable for specific selection of wines. Other types of profiles may be pre-defined for different types of items and products. The user preference profile is associated with a unique user identifier, according to one embodiment.

In one embodiment, upon detecting the transmitter and determining the identifier of the retail space section, the preference profile together with the unique user identifier and the retail space section identifier are sent by the mobile application to a cloud server system. At 230, the preference profile, the unique user identifier, and the retail space identifier are received at the cloud server system to be processed. At 240, a selection of one or more objects in the retail space is determined based on the received preference profile. The one or more objects are selected to match the preferences indicated in the preference profile. Parameter values of the user preference profile and of items profiles located at the respective retail space section may be compared to determine a matching score between the user preference and an item at the retail space section.

At 250, the determined selection of the one or more objects is sent to a computer. An example of the computer may be a single-board computer such as Raspberry Pi. Other computer systems may be used as well. In one embodiment, the selection may be sent to the computer in a message, e.g., via ZMQ publisher queue. The determined selection of one or more objects may be published by the cloud server system via a publisher socket. A topic of the message may be the retail space section identifier.

Upon receiving the message at the computer, at 260, a string representing the selection is sent to a controller. In one embodiment, the controller may be an Arduino microcontroller that communicates with the Raspberry Pi. Upon receiving the string representing the selection at the controller, at 270, the determined selection of one or more objects is outputted to one or more electronic components. At 280, the one or more electronic components act on the retail space section in accordance with the determined selection. The one or more electronic components may be lights, for example. In such case, lights may be lightened up at corresponding positions as determined by the string representing the selection.

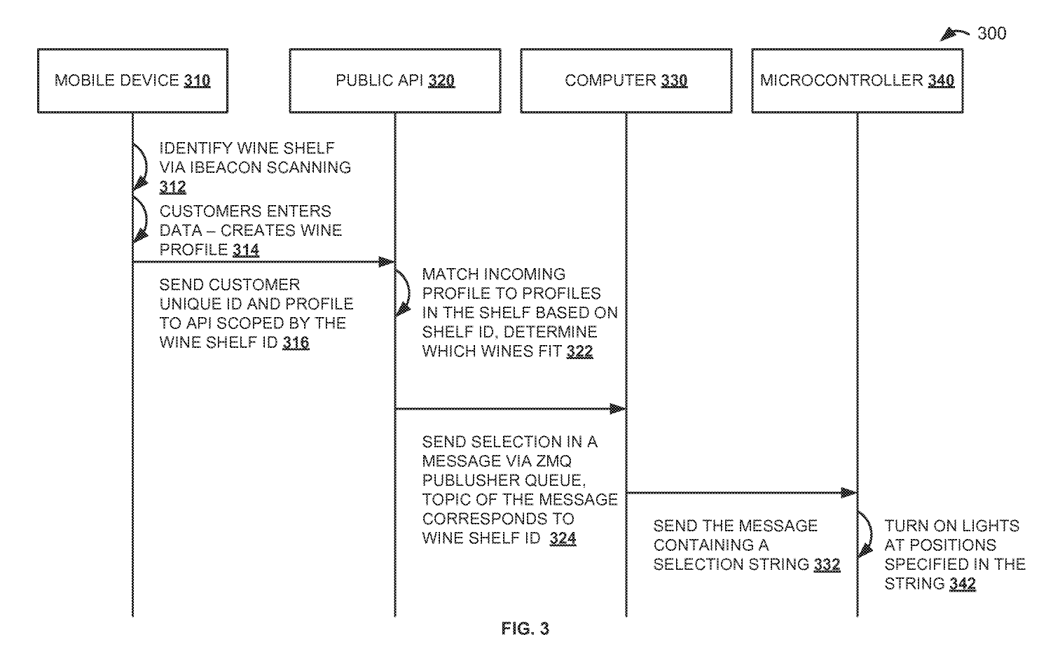

FIG. 3 illustrates process 300 to select one or more wines from a wine shelf, according to one embodiment. Other items for which user may have individual preferences and that can be physically located to a retail space section such as a shelf may be selected, according to various embodiments. The different wines may be associated with corresponding positions on the shelf. At 312, mobile 310 such as a smartphone identifies the wine shelf, e.g., via iBeacon scanning. One hardware iBeacon may be attached per wine shelf in a retail store or other space. Thus, a unique identifier of a iBeacon represents the identifier of the corresponding wine shelf, which is determined to be in proximity to the smartphone. In on embodiment, a mobile application is installed on the smartphone. The mobile application on the smartphone may prompt a user of the mobile application to answer a questionnaire. At 314, based on a filled in questionnaire, the mobile application may determine a wine preference profile. The wine preference profile may be associated with a unique customer identifier. In one embodiment, a wine preference profile of the user may be predefined.

At 316, the unique customer identifier and the wine preference profile of the customer are sent to a public application programming interface (API) 320 at a cloud server system. For example, the application installed on mobile device 310 accessed services provided by the cloud server system via public API 320. In one embodiment, the cloud server system exposes an API to client systems such as mobile applications, that conforms with Representational State Transfer (REST) architecture, e.g, is RESTful.

At the cloud server system, a matching is performed in response to receiving the wine preference profile and shelf identifier. For a number of wines there may be associated corresponding wine profiles, e.g., available at the cloud server system. The wine preference profile of the user may be matched to wine profiles of wines at the respective shelf. In one embodiment, at 322, the public API 320 matches the incoming wine preference profile of the user to wine profiles associated with wines in the shelf, where the shelf is determined based on shelf identifier. Thus, wine profiles against which the user preference profile is matched could be filtered based on the received shelf identifier. The matching process determines which wines of the shelf match or otherwise fit the wine preference profile of the user. In one embodiment, the matching is performed by the cloud server system to determine a selection of one or more wines.

At 324, the determined selection of one or more wines is sent in a message to computer 330 such as Raspberry Pi, the message may be sent via ZMQ publisher queue. A topic of the message corresponds to the wine shelf identifier. In one embodiment, each shelf may be associated with a corresponding computer 330 that maintains a ZMQ subscriber socket to receive messages with topic the respective shelf identifier. The selection may be represented by a string such as “1101000000000000” indicating that wines at positions 0, 1, and 3 are selected. In this example the shelf has 16 positions in total where a wine may be physically located. At 332, computer 330 sends the message containing the selections string to microcontroller 340 such as Arduino. Microcontroller 340 outputs the determined selection to one or more electronic components such as lights. At 342, microcontroller 340 turns on respective lights at positions specified by the received string representing the selection.

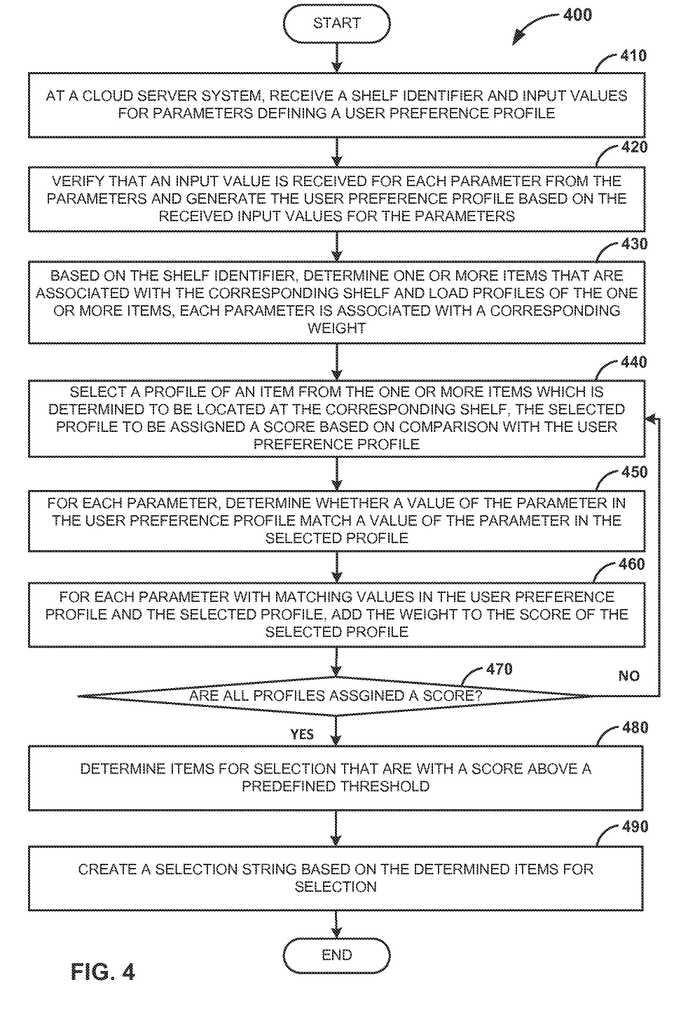

FIG. 4 illustrates process 400 to match a user preference profile to one or more items located at a retail space section, according to one embodiment. At 410, a shelf identifier and input values for parameters defining a user preference profile are received at a cloud server system. For example, an HTTP POST request from smartphone 130 is received at “/shelves/:id/profile” of cloud server system 110 (FIG. 1). Parameter “:id” is substituted with the received shelf identifier. At 420, it is verified whether an input value is received for the parameters. Exemplary parameters for which an input value may be expected corresponding to questions in a questionnaire for wines may include, but are not limited to: “customer_id”, “red.frequency”, “red.overall”, “red.aroma”, “red.strength”, “red.tannins”, “red.storage”, “white.frequency”, “white.overall”, “white.aroma”, “white.acidity”, “white.storage”, “white.strength”. In one embodiment, if an input value is missing for a parameter, an error message describing the missing parameter value may be generated. If input values are received for each of the parameters, the user preference profile is generated based on the received input values for the parameters.

At 430, one or more items that are associated with or located at the corresponding shelf are determined based on the received shelf identifier. Profiles of the determined one or more items are loaded to be matched to the generated user preference profile. The one or more items may be retrieved from a product repository or other database. In one embodiment, the parameters are associated with corresponding weights. The weights assigned to the parameters allow defining different levels of importance of the parameters in matching process 400. Table I below represents exemplary weights associated with the above-mentioned parameters that define a wine profile, according to the example. In one embodiment, for each sub-category, i.e., red wine or white wine, a maximum score for all the parameters are calculated. For example, 125 points for red wine.

```
let weights = {
  red : {
    overall: 50,
    aroma : 40,
    strength: 15,
    tannins : 15, //red
    storage : 5
  },
  white : {
    overall: 50,
    aroma : 40,
    strength: 15,
    acidity : 15, //white
    storage : 5
  }
}
```

Once the one or more items associated with the corresponding shelf and their corresponding profiles are determined, at 440, a profile of an item from the one or more items is selected to be matched to the user preference profile by comparing parameters' values. Based on the comparison, a score is assigned to the selected profile. In one embodiment, a score is calculated for each item from the one or more items. At 450, for each parameter, it is determined whether a value of the parameter in the user preference profile matches a value of the parameter in the selected profile. At 460, for each parameter with matching values in the user preference profile and the selected profile, the weight of the parameter is added to the score of the selected profile. Thus, when parameter values of the selected item profile are compared against the parameter values of the user preference profile, the total score is calculated and assigned to the selected item profile. To illustrate with an example, each loaded wine is iterated over and a new entry for the selected wine is created in an array. One dimension of the array represent the wine identifier, another dimension of the array may represent the total score assigned to the wine profile for the respective wine. All profile parameter values of the stored wines for the shelf identifier are compared with input values that may be derived from answers submitted by a user via a mobile device. If there is a match, the weight associated with the corresponding parameter is added to an overall score for the wine being iterated over. As a result, an array may be created with items containing the wine identifier and the score of the wine. Before the score is added to the results array, it may be mapped to a max of 100−score=Math·round(score/max*100), where 100 is a range. Other value may be assigned to the range. In one embodiment, values may be checked whether they are an exact match. In one embodiment, for some attributes such as “tannins” of a wine, a partial score may be assigned when the user's answer diverges slightly. For example, the value of tannins inputted by the user may be a score of 3 (from 0 to 4 overall) while the profile of the wine currently evaluated may have a tannin value of 2. In such a case, part of the weight of the parameter may be added to the overall score of the profile of the wine currently evaluated.

At 470, it is checked whether profiles of all items associated with the corresponding shelf are iterated over and are assigned a score. If there are items without a score assigned to their profiles, process 400 continues at 440 by selecting the next profile to be assigned a score. If a score is assigned to the profiles of all items associated with the corresponding shelf, the item that are with a score above a predefined threshold are determined for selection at 480. At 490, a selection string based on the determined items is created. For example, the array may be reduced to objects that have a score above the predefined threshold. Next, the array of objects may be further reduced to include positions in the shelf for the objects above the predefined threshold. Thus, an array with items' positions that are “on” is returned—e.g., “[0, 1, 3]” for items at position “0”, “1” and “3” that scored above the threshold, which indicates sufficient matching degree with the user preference profile. The string representing the selection may be, for example, 16 character string, with “0” or “1” at each position. If items at positions 0, 1 and 3 are with score above the predefined threshold, string “1101000000000000” may be generated.

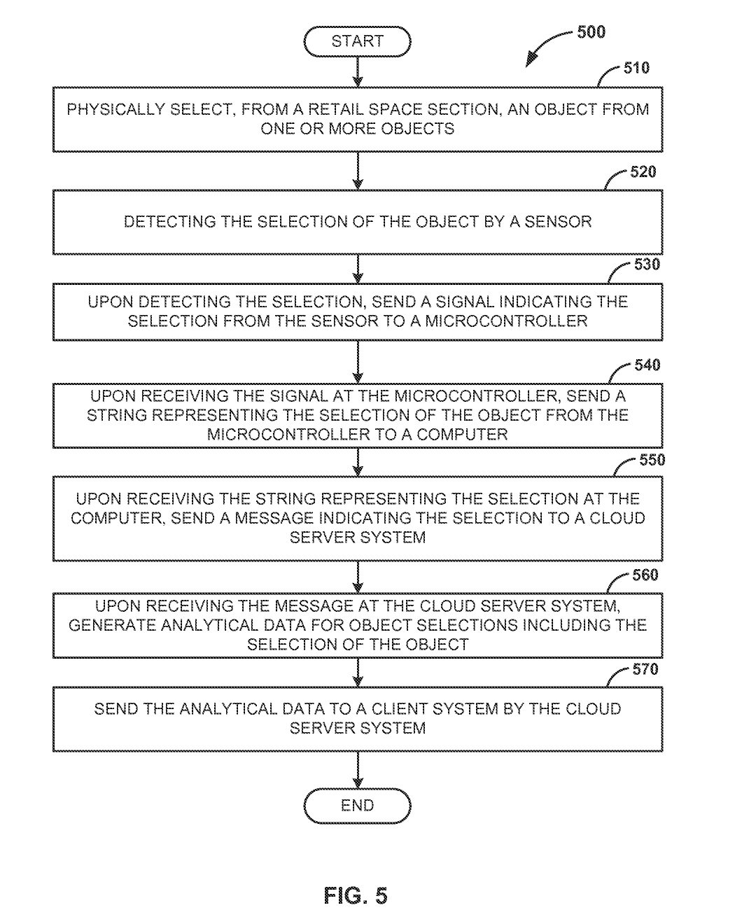

FIG. 5 illustrates process 500 to capture real-time physical selections of objects from a physical retail space, according to one embodiment. At 510, an object from one or more objects within is physically selected from the retail space section. The object may be selected for example, by uplifting the object or otherwise interacting and moving the object from the retail space section, according to one embodiment. The physical selection of the object may be performed, for example, by a customer interacting with the object in the retail space section. At 520, the selection is detected by a sensor. In another example, the selection may be detected by other device such as an electronic switch. For example, the selection may be detected by a micro switch actuated by physical force such as a movement of the object. Upon detecting the selection, at 530, a signal indicating the selection is sent to a microcontroller from the sensor. For example, upon uplifting the object, an actuator button of an electronic switch produces electrical signal from the electronic switch to the microcontroller indicating the selection.

Upon receiving the signal at the microcontroller, at 540, a string representing the selection of the object is send real-time from the microcontroller to a computer such as a single-board computer. Upon receiving the string representing the selection at the computer, at 550, a message indicating the selection is sent from the computer to a cloud server system. The message may include a retail space section identifier from where the object is selected. In one embodiment, a mobile application running on a mobile device may identify the retail space section in proximity to the mobile device by detecting the retail space section identifier transmitted by a transmitter attached to the retail space section. Upon receiving the message at the cloud server system, at 560, analytical data for object selections including the selection of the object is generated by the cloud server system. For example, the cloud server system, upon receiving the input representing the physical selection of the item, may aggregate or analyze object selection over a period of time, per bottle, per position, etc. Various data analyses may be performed by the cloud server system for captured physical selections of objects from the retail space. In one embodiment, at 570, the cloud server system sends the data analysis to one or more client systems. For example, the data analysis may be sent to a mobile device to display the data analysis.

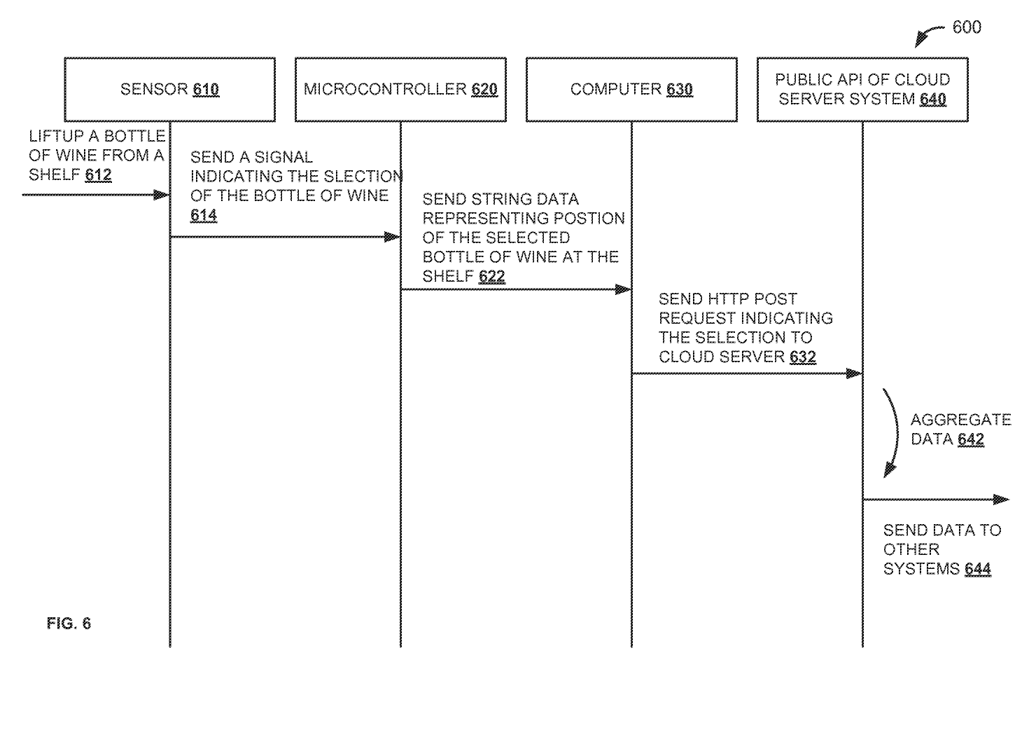

FIG. 6 illustrates process 600 to capture real-time selections of wines from a shelf, according to one embodiment. At particular positions on a shelf electronic switches may be installed to detect movement of objects located at the respective positions. The electronic switches communicate with a microcontroller such as Arduino, which may be installed for the shelf. In turn, the Arduino is connected to a communication broker such as a Raspberry Pi for communication with a cloud API. At 612, a bottle of wine is lifted or otherwise moved from a shelf. The movement of the bottle of wine indicates a selection of the bottle of wine by a customer interacting with the wine in the shelf. In other embodiments, physical selections of any other products or items may be captured. The selection is detected by a sensor 610. In another embodiment, the selection may be detected by an electronic switch. For example, the selection may be detected by a micro switch such as a micro switch from MicroSwitches 170 in FIG. 1. Sensor 610 is actuated by physical force from the movement of the bottle of wine. Upon detecting the selection, at 614, sensor 610 sends a signal to microcontroller 620 indicating the selection of the bottle of wine. In one embodiment, microcontroller 320 may be an Arduino board.

Upon receiving the signal, at 622, microcontroller 620 sends real-time a string data representing the selection of the bottle of wine from to computer 630. In one embodiment, the computer may a single-board computer such as Raspberry Pi. Since, sensor 610 is attached to and associated with a shelf position, the string data represents the position of the shelf from where the bottle of wine is moved. Upon receiving the string data representing the selection of the bottle of wine, at 632, computer 630 sends a message such as an HTTP POST request indicating the selection to public API of cloud server system 640. Upon receiving the message indicating the selection, at 642, the cloud server system calculates analytical data for wine selections including the selection of the bottle of wine. For example, upon receiving input for the selection of the bottle of wine, cloud server system 640 may aggregate wine selection over a period of time, per bottle, per position at the shelf, calculate other totals, etc. In one embodiment, at 644, cloud server system 640 may send the calculated data analytics to one or more other systems. For example, the data analytics may be sent to and displayed by a mobile application installed on a mobile device.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as Compact Discs Read-Only Memory (CD-ROMs), Digital Video Discs (DVDs) and holographic devices; magneto-optical media; and hardware devices that are specially configured to store and execute, such as application-specific integrated circuits (“ASICs”), programmable logic devices (“PLDs”) and Read-only memory (ROM) and Random-access memory (RAM) devices, memory cards used for portable devices such as Secure Digital (SD) cards. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

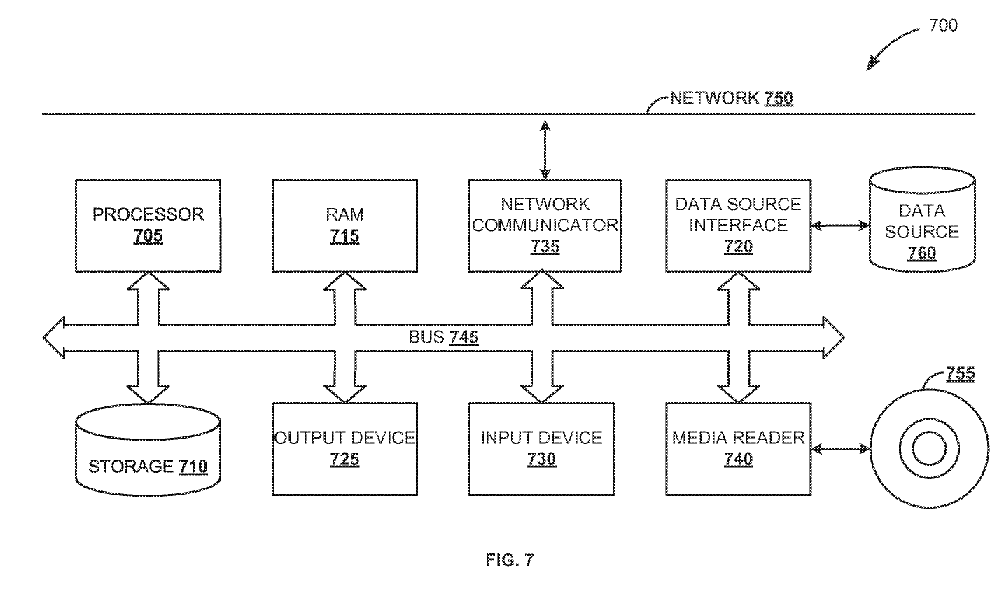

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. These output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

What is claimed is:

1. A system comprising:
a computer to receive, via a subscriber socket, a selection of an item from a plurality of items within a retail space, wherein the selection determined by a cloud server system based on a user preference profile and the computer subscribed to listen for a message with a topic that is an identifier of the retail space;
a microcontroller to output the determined selection to an electronic component from one or more electronic components in the retail space upon receiving the determined selection sent by the computer; and
the electronic component to act on the retail space in accordance with the determined selection.

2. The system of claim 1 further comprising:
a transmitter to automatically notify devices in proximity for presence of the transmitter by transmitting the identifier of the retail space where the transmitter is attached.

3. The system of claim 2 further comprising:
a mobile device to automatically detect the transmitter when in proximity; and
upon detection of the transmitter, a mobile application installed on the mobile device to receive the user preference profile and the identifier of the retail space transmitted by the transmitter.

4. The system of claim 1 further comprising:
a sensor to send a signal to the microcontroller upon moving the selected item from the retail space, the signal indicating the physical selection of the item triggered by the uplifting the selected item.

5. The system of claim 4, wherein the microcontroller further to:
upon receiving the signal indicating the physical selection of the item, send a string representing the physical selection of the item to the computer.

6. The system of claim 4, wherein the microcontroller further to:
upon receiving a string representing the physical selection of the item at the computer, updating the cloud server system that the item is selected; and
the cloud server system to generate analytical data for a plurality of physical item selections including the selection of the item.

7. The system of claim 6, wherein a client system to receive the analytical data sent by the cloud server system.

8. The system of claim 1, wherein the computer is a Raspberry Pi.

9. The system of claim 1, wherein the microcontroller is an Arduino.

10. The system of claim 2, wherein the transmitter is an iBeacon™.

11. A computer implemented method to select an item in a smart retail space, the method comprising:
at a cloud server system, receiving a user preference profile and a retail space identifier sent by a mobile application running on a mobile device;
determining a selection of an item from a plurality of items in the smart retail space based on the received user preference profile, wherein the selected item matching the user preference profile;
at a computer, receiving the determined selection published by the cloud system, wherein the computer subscribed via a subscriber socket to listen for a message with topic that is the received retail space identifier;
at a microcontroller, receiving a string data representing the determined selection send by the computer;
the microcontroller outputting the determined selection to one or more electronic components in the retail space; and
the one or more electronic components acting on the retail space in accordance with the determined selection.

12. The method of claim 8, wherein determining the selection further comprises:
based on the retail space identifier, loading a plurality of profiles of the plurality of items to be matched to the user preference profile:
selecting for evaluation a profile from the loaded plurality of profiles;
comparing parameter values in the user preference profile to corresponding parameter values in the selected profile; and
determine a score of the selected profile, the score calculated by aggregating parameter weights for parameters with matching values in the user preference profile and the selected profile.

13. The method of claim 9 further comprising:
determine the item for selection, wherein the determined item for selection has a score above a predefined threshold.

14. The method of claim 8 further comprising:
transmitting by a transmitter an identifier of the retail space where the transmitter is attached.

15. The method of claim 11 further comprising:
automatically detecting signals from the transmitter by a mobile device when in proximity; and
upon detection of the signals from the transmitter, a mobile application installed on the mobile device sending the user preference profile and the identifier of the retail space transmitted by the transmitter.

16. A computer implemented method to capture real-time physical selections of items from a physical retail space, the method comprising:
physically selecting an item from a plurality of items from the physical retail space;
detecting in real-time the physical selection by a sensor;
receiving at a microcontroller a signal indicating the selection, wherein the signal sent by the sensor upon detecting the selection;
receiving a string representing the physical selection of the item at a computer, wherein the selection sent by the microcontroller; and
upon receiving the string representing the physical selection at the computer, receiving a message indicating the physical selection to a cloud server system to be processed by the cloud server system, wherein the message sent by the computer.

17. The method of claim 16 further comprising:
upon receiving the message at the cloud server system, generating analytical data for physical item selections including the physical selection of the item currently processed by the cloud server system.

18. The method of claim 17 further comprising:
sending the analytical data to a client system by the cloud server system.

19. The method of claim 16 further comprising:
physically selecting the item from the physical retail space by uplifting the item from the physical retail space.

20. The method of claim 16 further comprising:
storing an association between an item from the plurality of items and a position at the physical retail space
